(19) United States
(12) Patent Application Publication
(10) Pub. No.: US 2006/0051441 A1
(43) Pub. Date: Mar. 9, 2006

(54) Cooling device

(76) Inventor: Siegfried Kogler, Bad Hall (AT)

Correspondence Address: RYAN KROMHOLZ & MANION, S.C., POST OFFICE BOX 26618, MILWAUKEE, WI, 53226, US

(21) Appl. No.: 11/211,961

(22) Filed: Aug. 25, 2005

(30) Foreign Application Priority Data
Aug. 26, 2004 (AT) A1441/2004

(51) Int. Cl. B29D 31/00; D01D 5/00

(52) U.S. Cl. 425/67

(57) ABSTRACT

A cooling device for extruded plastic profiles has a cooling chamber with cold water, and the plastic profile to be cooled is passed through this. The cooling chamber also has at least one supply pipe for the cold water in the floor, or in a side wall. An overflow edge for the cold water is positioned on at least one side wall. The height of the overflow edge can be used to set the water level regardless of the pressure.

### RELATED APPLICATION

This application claims the benefit of prior co-pending Austrian Application No. A1441/2004, filed on 26 Aug. 2004.

### SUMMARY OF THE INVENTION

The invention refers to a cooling device for extruded plastic profiles that has a cooling chamber with cool water, which the plastic profile to be cooled passes through. The cooling chamber has a floor, front and side walls, plus at least one supply of cold water in the floor or a side wall.

When manufacturing plastic profiles, for example profiles for PVC window frames, the plastic is pressed through a profile die at the end of the extruder, and then has to be cooled whilst retaining its original dimensions. This cooling process can involve the use of, amongst others, cooling devices where the extruded plastic profile is passed through a cooling chamber filled with cold water. State-of-the-art cooling chambers include those that are filled either completely or partly with cold water. The cold water is supplied either via a supply pipe mounted on the inlet side, or via several supply pipes distributed along the length of the cooling chamber. The cold water then flows through the cooling chamber, and is drained through an outlet at the outlet end.

The problem with cooling devices of the inlet type is achieving cooling performance that can also take into account, or can be set according to, the varying cooling requirements along the length of the cooling area, and the varying profile shapes.

This problem can be resolved using a cooling device with the characteristics listed in claim 1.

In this invention, the cooling water is not drained at the end of the cooling chamber or cooling zone, but using an overflow edge in at least one side wall.

This opens up several opportunities. On the one hand, a flow component can be created as required at right angles to the plastic profile, which can then be moved through particularly well if two or more supply pipes for the cold water are distributed along the length of the cooling chamber.

On the other hand, the height of the overflow edge from the floor can be either constant or variable along the full length of the cooling chamber. This method allows the water level at the end of the cooling zone, for example, to be higher or lower than at the start of the cooling zone, which makes it possible, for example, to allow certain sections of the plastic profile being cooled to protrude from the water at the start or end, if these require cooling to a lower degree or for a shorter period.

An alternative version of the invention can ensure that the height of the overflow edge above the floor is adjustable. This makes it very easy to adjust the water level to different profile shapes.

In this very simple version of the invention, the overflow edge is formed from the upper edge of the side wall.

In an alternative version, the overflow edge is made up of at least one or preferably several side-wall openings along the length of the cooling chamber. The height of an individual opening or all of the openings above the floor can be adjusted.

One single supply pipe for the cold water can be provided in the invention, although a preferable version would have two or more supply pipes for the cold water distributed along the length of the cooling chamber. This allows a better setting of the cold water flow, and thus of the cooling effect in different sections of the cooling zone.

As standard in state-of-the-art technology, at least one supporting aperture for the plastic profile can be provided in the cooling chamber. Regardless of the opening for the plastic profile, this supporting aperture can be equipped with additional openings, which allows a flow through the supporting aperture along the length of the cooling chamber.

A preferred version of the invention can ensure that the opposite side of the side wall from the cooling chamber is equipped with a collection chamber with at least one outlet for overflowing cold water, in order to drain the cold water away. This collection chamber would collect the water that flows over the overflow edge in the cooling chamber, and allow it to be drained away.

The invention thus allows the drain to be located either in an external wall or in the floor of the collection chamber.

When hollow plastic profiles are being cooled, the whole device is usually subjected to low pressure to prevent the still malleable walls of the hollow plastic profile from being pressed inwards by the water pressure. The design of the invention can therefore incorporate a housing that surrounds the cooling chamber and, if necessary, the collection chamber, to which a vacuum pump is connected.

This brings a further major advantage of the invention into play. Fluctuations of the low pressure in the air above the cooling liquid, which interacts with the suction pressure used to extract the cooling liquid, can lead to fluctuations in the level of the cooling liquid in state-of-the-art technology. This invention, in contrast, uses the height of the overflow edge to determine the level of the liquid, so that pressure fluctuations cannot lead to fluctuations in the level of the liquid.

Finally, it can also be ensured that the invention is designed symmetrically with regard to a vertical longitudinal centre plane; i.e. that the cooling device features, such as the side wall—possibly with an adjustable overflow edge height, the inlets and outlets for cold water and the collection chamber along either the plastic profile are laid out in a fundamentally symmetrical arrangement.

Further preferred versions of the invention are a topic for the remaining sub-claims.

Further characteristics and advantages of the invention can be found in the following description of preferred versions of the invention, with reference to the attached illustrations.

### BRIEF DESCRIPTION OF THE DRAWINGS

FIG. 1 shows a cross-section of an initial version of the invention.

FIG. 2 is a cross-section of a second version of the device with a symmetrical layout.

FIG. 3 is a transverse view of part of the version shown in FIG. 2.

FIG. 4 is a side view of a device corresponding to the invention.

FIG. 5 is a transverse view of a invention-related mounting frame for the device.

### DESCRIPTION OF THE PREFERRED EMBODIMENT

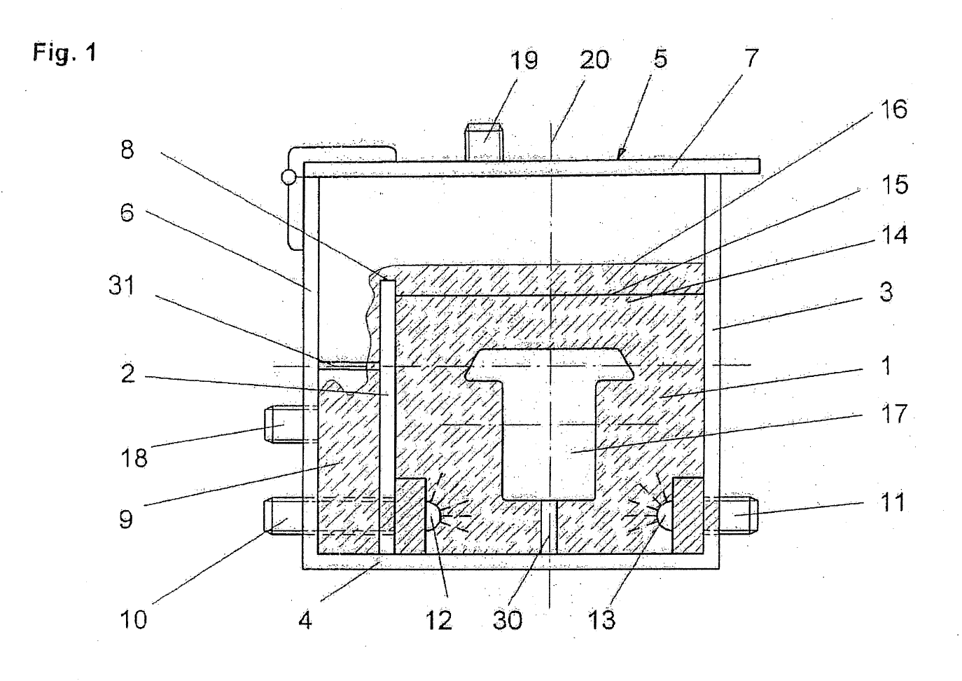

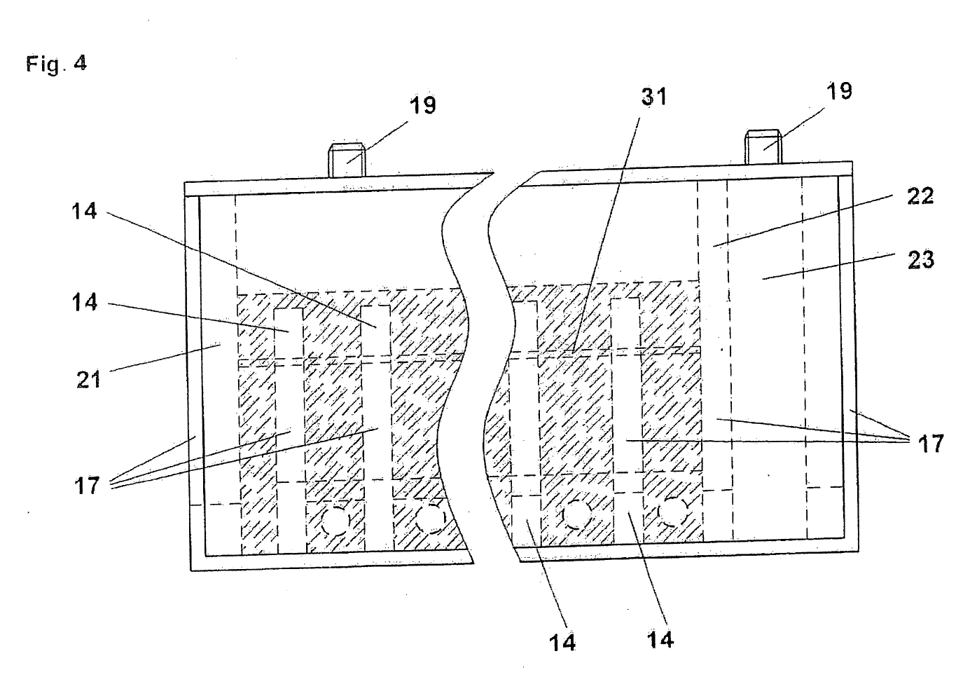

FIG. 1 shows an initial version of the cooling device, which can be used to cool a plastic profile with, for example, a T-shaped outline. The cooling device basically consists of a cooling chamber 1, which contains a cooling liquid, usually water. The cooling chamber 1 is bounded by side walls 2, 3, a floor 4, plus front walls 21, 22 which are not shown (FIG. 4). The whole cooling device is surrounded by a housing 5, where the side wall 3 is also an external wall for the housing 5. An external wall 6 and a cover 7 are part of the design.

As FIG. 1 shows, the side wall 2 and its upper edge 8 form an overflow edge for the cold water, and the cold water flows over this from the cooling chamber 1 into the collection chamber 9. The cold water is fed in via pipes 10 and 11, which are mounted in the side walls 2 and 3 across the length of the cooling chamber 1. The supply pipes 7 and 11 open into the nozzles 12 and 13.

As FIG. 4 shows, the cooling chamber 1 contains several supporting apertures 14, and the nozzles 12 and 13 are arranged between them. The apertures 14 contain a central opening 17, through which the plastic profile being cooled is passed. The apertures can also be produced across the whole area; i.e. so they subdivide the cooling chamber 1 into separate sections, or equipped with additional openings that are not shown in the drawings, so that the cold water can flow along the cooling chamber 1. The supporting apertures 14 can also have an upper edge 15, the height of which is less than the height of the overflow edge 8. The height of the upper edge 15 can also be equal to or higher than the overflow edge 8, and thus exceed the water level 16 in the area of the cooling chamber 1, where parts of the profiling opening 17 can also protrude above the water level 16 if required. This can be an advantage if some sections of the extruded profile to be cooled need to be cooled more slowly than others in the cold water area. It can also be used as a simple way of setting a different water level in different sections.

As FIG. 1 shows, the water level 16 is determined by the overflow edge 8, whereby the water flows into a collection chamber 9 created between the side wall 2 and the external wall 6. The height of the overflow edge 8 can therefore be used to set the water level in the cooling chamber 1. The height of the overflow edge 8 can be constant over the full length of the cooling chamber 1, or it can have a height that varies in different sections, to use the varying water level to a different cooling speed for the extruded profile in different sections.

The height of the side wall 2 can also be adjusted, so the water level 16 can be changed quickly and simply where necessary. This can be done, for example, with a two-section or multi-section side wall 2 the height of which can be adjusted, or with a slider or similar piece of equipment on the side wall 2.

The water is suctioned out of the collection chamber 9 via one or more drainage pipes 18 in a relatively simple process, as the water level in the collection chamber 9 and/or, where applicable, crosswise or lengthwise flows in this area have no effect on the water level in the cooling chamber 1, and thus on the cooling of the profile.

As the cooling chamber 1 is surrounded by a closed housing 5, it can be subjected to low pressure using a connection 19. The vacuum has a very even effect across the whole cooling device, and can be set variably, whereby the water level 16 in the cooling chamber 1 remains constant even if there are pressure fluctuations in the housing 5, as the level is determined by the overflow edge 8 regardless of the pressure.

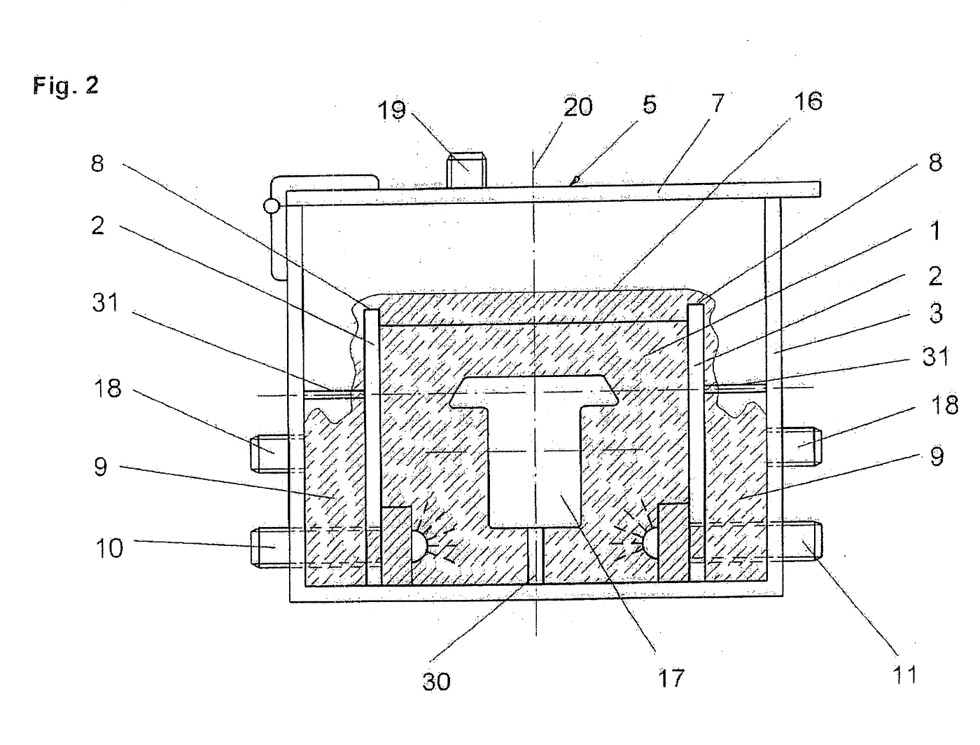

FIG. 2 shows an alternative version of the invention, which has broadly the same structure as the version in FIG. 1, but is designed symmetrically with regard to a vertical longitudinal centre plane; i.e. with a collection chamber 9 on both sides, not just on the left-hand side. All other parts of the cooling device, such as the side wall 2 and the drain 19, are also designed symmetrically.

FIG. 4 shows a side view of the cooling device in question. Both the front walls 21 and 22, which form the front and back edges of the cooling chamber 1 when viewed in the direction of movement, can also be seen here. An additional chamber 23 can be located behind the rear front wall 22 when viewed in the direction of movement; this is not filled with cold water, meaning that the cooled plastic profile is drier it would normally be in state-of-the-art technology when it leaves the cooling device.

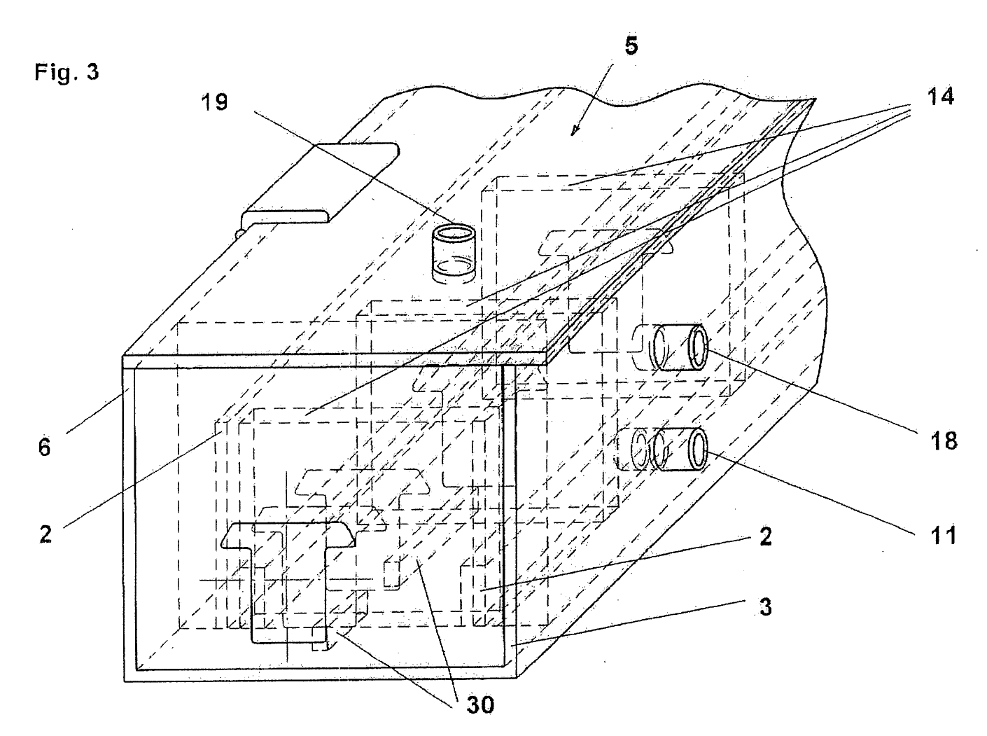

FIGS. 1, 2 and 3 show an optional dividing wall 30 below the central opening 17, which is used to prevent the cold water that is piped in from flowing from underneath the profile. This can be used to force the flow upwards. Turning the water supply on and off on one side can also be used to allow the profile to be cooled to different degrees on both sides.

FIGS. 1 and 2 also show a filter 31, which lies horizontally about halfway up the side of the collection chamber 9. This can be used to filter out impurities in the cold water outside the cooling chamber 1, before it is suctioned out of the collection chamber 9 through the drains 18.

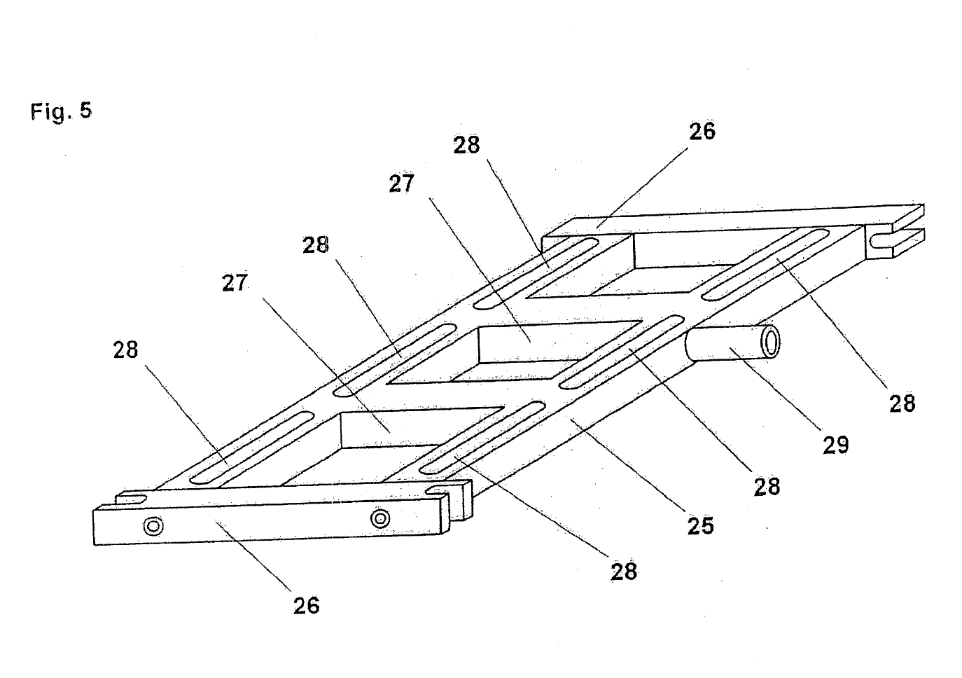

FIG. 5 shows a mounting frame 24 on which the cooling device in question can be mounted. This mounting frame is particularly advantageous if the drainage pipes for the water from the collection chambers 9 are not connected to the side walls as shown in the examples in FIG. 1 to 4, but where the cold water is drained from the collection chambers 9 through the floor 4 instead. The mounting frame 24 basically has two longitudinal braces 25, and two cross braces 26 at the front. Two connection braces 27 are also planned in the central area. Three elongated hole slots 28 are included on the upper side of each of the longitudinal braces 25, which fit to the openings in the floor 4 that are mounted in the area of the collection chambers 9. Water flows through the openings in the floor 4 and the elongated hole slots 28 into the hollow longitudinal braces 25, which are connected to one another via the connection braces 27, which are also hollow. The cold water is finally suctioned out via a connecting piece 29, through which the water is suctioned by a cyclone, for example.

To sum up, an example of the invention can be described as follows:

A cooling device for extruded plastic profiles has a cooling chamber 1 with cold water, and the plastic profile to be cooled is passed through this. The cooling chamber 1 also has at least one supply pipe 10, 11 for the cold water in the floor 4, or in a side wall 2, 3. An overflow edge 8 for the cold water is positioned on at least one side wall 2. The height of the overflow edge 8 can be used to set the water level 16 regardless of the pressure.

1. A cooling device for extruded plastic profiles, said cooling device including a cooling chamber with cold water, through which the plastic profile to be cooled is passed, the cooling chamber including a floor, front walls, side walls, at least one supply pipe for the cold water, and an overflow edge for the cold water attached to at least one side wall.

2. The cooling device according to claim 1, wherein the height of the overflow edge is adjustable above the floor.

3. The cooling device according to claim 2 wherein the overflow edge is formed from an upper edge of the side wall.

4. The cooling device according to claim 3, wherein the height of the overflow edge above the floor is constant along the full length of the cooling chamber.

5. The cooling device according to claim 1, wherein the overflow edge is formed from at least one opening in the side wall.

6. The cooling device according to claim 5, wherein two or more of the openings along the length of the cooling chamber are positioned along the side wall, and that the height of the overflow edge and the openings above the floor is the same over the length of the cooling chamber.

7. The cooling device according to claim 1, wherein two or more of the supply pipes for the cold water are distributed along the length of the cooling chamber.

8. The cooling device according to claim 1, further including at least one supporting aperture for the plastic profile in the cooling chamber.

9. The cooling device according to claim 8, wherein the supporting aperture has openings.

10. The cooling device according to claim 9, wherein a collection chamber with at least one drain for overflowing cold water is located on the opposite side of the side wall from the cooling chamber.

11. The cooling device according to claim 10, wherein the drain is located in an external wall of the collection chamber.

12. The cooling device according to claim 10, wherein the drain is located in the floor of the collection chamber.

13. The cooling device according to claim 1 further including a mounting frame below the floor, into which at least one drain opens.

14. The cooling device according to claim 13, wherein two or more drains that lead to a joint drainage pipe open into the mounting frame.

15. The cooling device according to claim 14, further including a suction pump attached to the drains and the drainage pipe.

16. The cooling device according to claim 10 further including a housing that surrounds the cooling chamber and the collection chamber, to which a vacuum pump is connected.

17. The cooling device according to claim 1, further being symmetrical with reference to a vertical longitudinal centre plane.

18. The cooling device according to claim 1, wherein a filter is provided after the overflow edge viewed in the flow direction of the cold water.

19. The cooling device according to claim 18, wherein the filter is located in the area of the collection chamber.

20. The cooling device according to claim 19, wherein the filter is located halfway up the collection chamber.
